(19) United States
(12) Patent Application Publication
(10) Pub. No.: US 2019/0035284 A1
(43) Pub. Date: Jan. 31, 2019

(54) SYSTEMS AND METHODS FOR INCREASING PLATOONING EFFICIENCY

(71) Applicant: Joyce Tam, Pleasanton, CA (US)

(72) Inventor: Joyce Tam, Pleasanton, CA (US)

(73) Assignee: Peloton Technology, Inc., Mountain View, CA (US)

(21) Appl. No.: 16/144,937

(22) Filed: Sep. 27, 2018

Related U.S. Application Data
(63) Continuation-in-part of application No. PCT/US18/41684, filed on Jul. 11, 2018.
(60) Provisional application No. 62/531,293, filed on Jul. 11, 2017.

(51) Int. Cl. G08G 1/00; G05D 1/02; G05D 1/00

(52) U.S. Cl. CPC G08G 1/22; G05D 1/0293; G05D 2201/0213; G05D 1/0088; G05D 1/0297

(57) ABSTRACT

Systems and methods for increasing the efficiency of vehicle platooning systems are described. In one aspect, data associated with roads is received by a system. The data received by a system may include information regarding a number of vehicles capable of platooning on a road. This data may be historical data or real-time data. Based on the received data that indicates how many vehicles capable of platooning may be on a road at a given time a system may direct other platoonable vehicles to travel on the same road at the given time to improve their chances of being able to platoon with other vehicles.

### CROSS-REFERENCE TO RELATED APPLICATIONS

This application is a continuation-in-part of PCT Application PCT/US18/41684, filed Jul. 11, 2018, which claims priority from U.S. Provisional Patent Application No. 62/531,293, filed Jul. 11, 2017. All of these applications are incorporated by reference herein in their entirety.

### BACKGROUND

Enabling a vehicle to follow closely behind one vehicle safely through partial or full automation has significant fuel savings, safety, and/or labor savings benefits, but is generally unsafe when a driver tries to do this manually. Presently, during normal driving, vehicle motion is controlled either manually, by a driver, or by convenience systems, such as cruise control or adaptive cruise control. The various types of cruise control systems control vehicle speed to make driving more pleasurable or relaxing, by partially automating the driving task. Some of these systems use range sensors and/or vehicle sensors to control the speed to maintain a constant headway relative to the leading vehicle (also referred to herein as a front vehicle). In general, these cruise control systems provide minimal added safety, and do not have full control of the vehicle (in terms of being able to fully brake or accelerate).

Driver control does not match the safety performance of even current systems, for several reasons. First, a driver cannot safely maintain a close following distance. In fact, the relatively short distances between vehicles necessary to get any measurable fuel savings results in an unsafe condition if the vehicle is under driver control, thereby risking a costly and destructive accident. Further, the driver is not as capable of maintaining a constant headway as an automated system is. In fact, a driver trying to maintain a constant headway often causes rapid and large changes in command (accelerator pedal position for example), resulting in a loss of efficiency.

Thus, it would be desirable to have reliable and economical semi-automated vehicular convoying or platooning systems which enable vehicles to follow closely together in a safe, efficient, convenient manner.

However, even if a system enables vehicles to follow together in a safe and convenient manner, it may still be difficult to create efficiencies when a variety of vehicles—which may or may not be capable of platooning—are located throughout various highways, and have trouble locating each other. Thus, in some platooning systems, the ability to allow vehicles capable of platooning to find each other is desirable, particularly since there are no systems currently available in the art to perform such tasks.

### SUMMARY

The system and methods comprising various aspects of the disclosure described herein provide for more efficient platooning. For example, without limitation, aspects of the present invention enable the determination of a time for a platoonable vehicle to travel on one or more roads. Road data may be received from a third-party source at a network operations center. This road data may include historical data associated with a road. Further, a time to travel on the one or more roads may be determined based on an estimated platoonable density of one or more roads, where a platoonable-vehicle density of one or more roads includes an amount of platoonable vehicles traveling on at least a portion of the one or more roads. Further, an estimated platoonable-vehicle density of one or more roads may be based on information received at the network operations center. In addition, a current location of a vehicle may be taken into account when determining a time to travel on the one or more roads.

Systems described herein, without limitation, may include a network operations center configured to receive data associated with a road and determine a time to travel on the road. In determining the time to travel, a system may base its determination on a platoonable-vehicle density of a road and a location of a platoonable vehicle. A platoonable-vehicle density may be based on an amount of platoonable vehicles traveling on a road.

It will be appreciated by those skilled in the art that the various features of the present disclosure can be practiced alone or in combination. These and other features of the present disclosure will be described in more detail below in the detailed description of the disclosure and in conjunction with the following figures.

### BRIEF DESCRIPTION OF THE DRAWINGS

In order to describe the various aspects of the present disclosure, some detailed description now will be provided, by way of illustration, with reference to the accompanying drawings, in which:

FIG. 1 illustrates a diagram of a platooning system, in accordance with some embodiments;

FIG. 2 illustrates a block diagram of a platooning system, in accordance with some embodiments;

FIG. 3 illustrates a block diagram of a system including an electronic control unit, in accordance with some embodiments;

FIG. 4 illustrates an example map 400 including vehicles on roads, in accordance with some embodiments;

FIG. 5 illustrates an example map 500 including vehicles on roads, in accordance with some embodiments;

FIG. 6 illustrates a flow chart of an example process, in accordance with some embodiments; and

FIG. 7 illustrates an example computing system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention, including the description of a plurality of different aspects of the invention, including, in some cases, one or more alternatives. It will be apparent to those skilled in the art that the invention can be practice without implementing all of the features disclosed herein.

The Applicant has proposed various vehicle platooning systems in which a second, and potentially additional, vehicle(s) is/are automatically, or semi-automatically controlled to closely follow a lead/front vehicle in a safe manner. By way of example, U.S. application Ser. Nos. 15/605,456, 15/607,902; 13/542,622 and 13/542,627; U.S. Provisional Application Nos. 62/377,970 and 62/343,819; and PCT Application Nos. PCT/US2014/030770, PCT/US2016/049143 and PCT/US2016/060167 describe various vehicle platooning systems in which a trailing vehicle (also referred to herein as a rear vehicle) is at least partially automatically controlled to closely follow a designated lead vehicle. Each of these earlier applications are incorporated herein by reference.

One of the goals of platooning is typically to maintain a desired position between the platooning vehicles and/or a desired relative speed and/or a time headway (e.g., a gap may refer to a distance, a headway, or both). Thus, it should be appreciated that, herein, any reference to the term “gap” could refer to a distance, a headway, or both. Further, while the term “maintain” is used throughout this disclosure, maintaining may mean staying within a gap (distance/headway), staying at a gap, and/or keeping at least a certain gap. Further, a desired gap may include be a relative distance or time headway and/or angle/offset. A longitudinal distance or time headway is frequently referred to herein as a “target gap”. That is, it is desirable for the trailing vehicle (e.g., a rear vehicle) to maintain a designated gap relative to a specific vehicle (e.g., a lead vehicle). The vehicles involved in a platoon will typically have sophisticated control systems suitable for initiating a platoon, maintaining the gap under a wide variety of different driving conditions, and gracefully dissolving (e.g., ending) the platoon as appropriate. It should be appreciated that herein, a gap may refer to a distance, a time headway, or either.

As described herein, the concept of platooning, also known as convoying, is still in its infancy. Academics have toyed with the concept over the last few decades, but to date there are no commercial systems on the road where a vehicle is at least partially controlled by another vehicle via a vehicle-to-vehicle connection (V2V). The benefits provided by such systems are obvious. Namely, the safety provided by these systems is far greater than a system where a rear vehicle doesn't begin to slow down until its radar or LIDAR sensors determine that a lead vehicle is slowing down. Further, by being able to follow another vehicle at a close distance, in some cases both a rear vehicle and a front vehicle may experience significant fuel savings.

As platoonable vehicles (e.g., vehicles capable of platooning) begin to roll out of the labs and into commercial production, their adoption faces significant challenges. For example, some people theorize that platooning may only work well when two platoonable vehicles depart a transportation hub at the same time and are traveling to the same location. However, for platooning to reach its full potential and provide greater savings (e.g., increase its efficiency), it would be desirable for systems to assist platoonable vehicles with meeting (e.g., rendezvousing) at locations other than where the respective vehicles start their trips. For instance, it would be desirable if a single platoonable vehicle traveling on a road could meet with another platoonable vehicle to start a platoon. With this capability, the likelihood that a fleet's vehicles will platoon may increase because, even when a fleet does not have two platoonable vehicles departing from the same location at the same time, the platoonable vehicles may be able to meet another platoonable vehicle on their route with which they may platoon (and thus increase the safety of the platooning vehicles and save fuel).

Herein, systems and methods for such a system are described. For example, systems (such as fleet management systems) that incorporate the ability for platoonable vehicles to meet up are described herein.

In various embodiments, a system may be able to determine the likelihood that a platoonable vehicle will meet another platoonable vehicle on a road, and in some cases determine a likelihood that the other platoonable vehicle will want to create a platoon.

In some examples described herein, a system may determine the likelihood that a platoonable vehicle may encounter another platoonable vehicle based on live and/or historical data. Live and/or historical data may be referred to at live and/or historical platooning data. For example, historical platooning data may be historical data that is based at least in part on platooning vehicles (e.g., on one or more road). Further, live and/or historical data may be based on breadcrumb data (e.g., vehicle location data received at various time intervals) from various telematics and/or platooning systems.

For example, a system (such as a fleet management system) may receive live and/or historical data associated with one or more roads or the area surrounding the road (e.g., city streets, highways, etc.) from its own fleet, sensors, and/or a third-party. The data may include traffic, weather, road conditions, information from government agencies, and the like. In some embodiments, the live data may include how many platoonable vehicles are traveling on a road and potentially other characteristics of the platoonable vehicles such as how much longer they will be driving, their total weight, or other factors that partially or totally determine whether they are a good fit for a platooning partner. As such, a system may show whether a road is ideal for platooning, whether it is not a good road for platooning, etc. Further, third-party data may be used to determine fuel efficiency on various routes, which may also be used to determine what route a vehicle should travel on.

In some embodiments, historical data may be used to estimate how many platoonable vehicles are likely to be traveling on a road. Based at least in part on this information, a system, a fleet, a driver, etc. may determine when vehicles should travel on the road to increase their likelihood of encountering other platoonable vehicles. It is contemplated that with this data, systems may schedule their vehicles to optimize their vehicles's opportunities to platoon. For instance, based on historical data a system may determine that one or more trucks are running a dedicated route (e.g., taking the same route every day). Based on this information, a system may cause/suggest that one or more additional vehicles travel on that route at the same time and platoon with the other vehicles that are running on the dedicated route. Of course, it should be appreciated that a system/dispatcher/fleet manager may cause/recommend/instruct a vehicle to depart at a particular time (e.g., within a threshold amount of time) and/or arrive at a particular time (e.g., within a threshold amount of time).

In various embodiments described herein, the amount of platoonable vehicles on a road may be referred to as road density (or simply “density” herein). For example, if a road has 2 vehicles capable of platooning within a 300-mile portion of that road, that road may be considered as having a low density. Conversely, if a 300-mile portion of a road has 300 vehicles capable of platooning, that road may be considered as having a high density. Thus, it may be desirable for fleets, drivers, etc. to travel on roads that have higher densities to increase the likelihood a vehicle will platoon with another vehicle. As described above, a determination of the density of a road may be based on real-time data associated with a road, historical data associated with a road, and/or other attributes of a road such as weather, time of day, construction, traffic, etc.

Moreover, in some embodiments, data received from a fleet, system, and/or third-party may indicate when vehicles are not running (e.g., due to maintenance). In such a case, a system may determine that at least one route and/or time to travel should be changed based at least in part on the at least one vehicle being out of commission. For example, if a fleet knows that 20 of its vehicles are out of commission and only 1 will be traveling on a given day, then it may be impractical to send the 1 vehicle on a route that is good for platooning, but otherwise less than optimal if not platooning.

Such a system may also be helpful when a user (e.g., a fleet) is determining whether it should platoon on a particular road. For example, if a new road opens in Tennessee, information could be collected about the vehicles traveling on that new road. If a threshold amount of vehicles are platooning on that road, then a system may determine that the road may be suitable for platooning and allow vehicles associated with the system to platoon on that road. In some embodiments, if a system determines that vehicles are platooning on a road in a certain manner (e.g., a threshold number of vehicles are platooning, that there are not many dissolves on a section of road, etc.) then the system may not require that road to be pre-approved prior to allowing vehicles platoon on it. In other words, if information collected about platooning vehicles on a road indicate that the road is safe to platoon on, a geofence may not be necessary and a system may allow vehicles to platoon on that road despite it not being within a geofence.

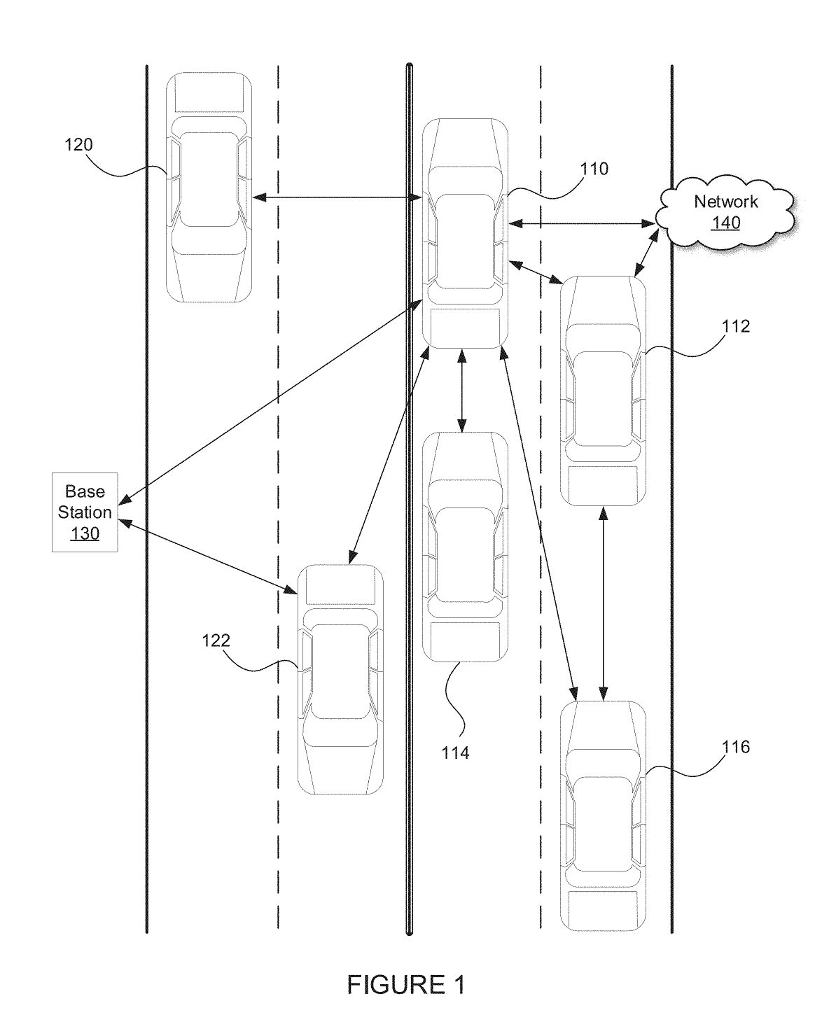

FIG. 1 illustrates a diagram of vehicles transmitting data, in accordance with some embodiments. FIG. 1. depicts multiple vehicles 110, 112, 114, 116, 120, and 122. FIG. 1 also depicts a base station 130 and a network 140. In various embodiments, vehicle 110 may transmit data (also referred to as information) to other vehicles 112, 114, 116, 120, and 122 directly, via base station 130, and/or via network 140. Vehicle 110 may also receive data from other vehicles 112, 114, 116, 120, and 122 directly, via base station 130, and/or via network 140. In some embodiments, a vehicle (e.g., vehicle 112) may retransmit information received from a first vehicle (e.g., vehicle 110) to another vehicle (e.g., vehicle 116) with or without additional information (e.g., information generated at vehicle 112 in addition to information received from vehicle 110).

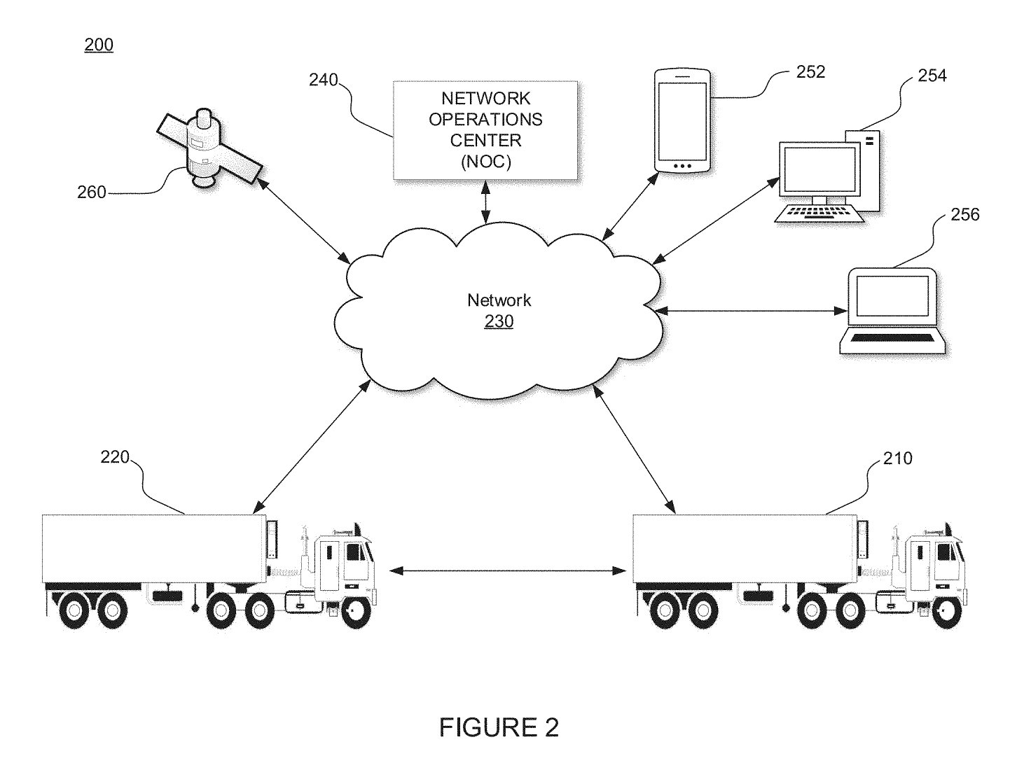

In various embodiments, vehicles 110, 112, 114, 116, 120, and 122 may be configured to platoon, and may platoon with one another. In some embodiments, vehicles may transmit and/or receive data (e.g., to a NOC (network operations center/cloud as shown in FIG. 2) and/or fleet management system, etc.) including, but not limited to data indicating: whether they are available to platoon; whether they are platooning; whether a platoon they were part of dissolved; what direction they are traveling; what direction they plan on traveling for a particular period of time; when they plan on stopping; where they plan on stopping; what route(s) they plan to travel; what type of platooning system they are equipped with; how many hours they have been on the road; weather they are capable of following the leader (e.g., if one or more vehicles can platoon without a driver); whether they are capable of being the leader in a follow-the-leader system; whether the vehicle is fully autonomous (e.g., capable of level 4 according to the SAE classification system); how much fuel they have saved; how much money they have saved; an area they are allowed to travel within; an area they are not allowed to travel outside of; whether they are capable of platooning on city streets; whether they are only capable of platooning on a highway; whether they are capable of platooning on non-public roads; whether they are capable of platooning in a particular construction site, mine, forest, etc.; and whether other attributes associated with a vehicle's account allows them to platoon. As should be understood, one or more of these attributes may be used to determine whether a vehicle can platoon with one or more additional vehicles, and whether a vehicle should platoon with one or more additional vehicles. It is contemplated that in some embodiments, a system may rank one or more vehicles with which a vehicle should platoon. In such an embodiment, if a target vehicle (e.g., a vehicle with a high ranking) that a first vehicle attempts to platoon with second vehicle before the first vehicle is able to platoon with the target vehicle, then the first vehicle may select another (e.g., the next) ranked vehicle that the system would like it to (e.g., determines that it should attempt to) platoon with.

In addition to these factors, other information that a vehicle may transmit and/or receive may include data including, but not limited to data associated with a/an: position, latitude, longitude, altitude, heading, speed, longitudinal and lateral acceleration, relative angle, type of load (e.g., type of materials a vehicle is carrying), brake status, brake pressure, brake system version, a version of a brake system, path history, path projection, travel plans, vehicle size, vehicle type, brake type, current operating mode (autonomous or manual), map data, traffic information, GPS augmentation information (e.g., delays from infrastructure), wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, battery, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, trailer position, current trailer position, past trailer position, tractor type, tractor height, transceiver type, current fuel, next planned stop, projected miles remaining until fuel tanks are empty, malfunctions, turn signals, LIDAR, radar, ultrasonic sensors, road surface, wheel angle, tire pressure, cabin temperature, engine temperature, trailer interior temperature, camera, fleet of vehicles, NOC, computer vision, other vehicle traveling in the same direction, other vehicle traveling in an opposite direction, and intervening traffic (e.g., cut-ins, also referred to as the situation when a vehicle enters an area between a lead vehicle and a rear vehicle). This information can be used by one or more vehicles, systems, fleets, etc. to determine whether a vehicle may platoon with another vehicle and/or to determine the best vehicle with which a vehicle may platoon. Again, it is contemplated that in some embodiments, a system may rank one or more vehicles with which a vehicle should platoon, and this ranking may be based on vehicle described above. In such an embodiment, if a target vehicle that a first vehicle wishes to platoon with platoons with another vehicle before the first vehicle is able to platoon with the target vehicle, then the first vehicle may move to another (e.g., the next) ranked vehicle that the system would like it to (e.g., determines that it should attempt to) platoon with.

FIG. 2 illustrates an example system 200 including two vehicles capable of platooning and associated communication links. Vehicles 210 and 220 are depicted by trucks which are capable of platooning, and can communicate with each other directly or through network 230. Direct communication between two vehicles can occur wirelessly via Dedicated Short Range Communications (DSRC) (e.g., the IEEE 802.11p protocol), which is a two-way short to medium range wireless communications technology that has been developed for vehicle-to-vehicle (V2V) communications. Of course, other communications protocols and channels may be used in addition to or in place of a DSRC link. For example, the inter-vehicle communications may additionally or alternatively be transmitted over a cellular communications channel such as 4G LTE Direct, 5G, a Citizen's Band (CB) Radio channel, one or more General Mobile Radio Service (GMRS) bands, one or more Family Radio Service (FRS) bands, Wi-Fi, Zigbee and/or any other now existing or later developed communications channels (e.g., wireless channels) using any suitable communication protocols either alone or in combination.

FIG. 2 also includes a network operations center (NOC) 240. NOC 240 may include one or more locations from which network monitoring, control, and/or management may be exercised over a communication network (e.g., the cloud/a multi-tenant environment). NOC 240 can oversee a complex network of vehicles, satellite communications, web applications, and/or management tools. Users of NOC 240 may be responsible for monitoring one or more networks, sub-networks, fleets of vehicles, and/or sub-fleets of vehicles that may require special attention to avoid degraded service. For example, NOC 240 may receive information about various vehicles 210 and 220 such as their locations and attributes, run various programs based on the received information, and send information back to vehicles 210 and 220, including indicating whether they are allowed to platoon.

In addition to NOC 240, client devices 252 (e.g., a smartphone or tablet), 254 (e.g., a desktop computer or terminal), and 256 (e.g., a laptop computer or terminal) may be used to send and/or receive information about vehicles 210 and 220, NOC 240, or information from canonical sources such as the Internet (e.g., Google Maps or another online map provider, a traffic provider, a weather provider, etc.). Client devices can be used to view attributes of vehicles 210 and 220 such as their location, an estimate of their weight, their speed, an amount of engine torque, amount of applied break, a destination, etc.

FIG. 2 also includes a satellite 260, which can send signals to network 230, NOC 240, and/or vehicles 210 and 220. Satellite 260 may be part of a satellite navigation system such as a global navigation satellite system (GNSS). GNSSs include the United States's Global Positioning System (GPS), Russia's GLONASS, China's BeiDou Navigation Satellite System, and the European Union's Galileo. Based on information sent from satellite 260, systems described herein can determine locations of vehicles 210 and 220.

Of course, it should be appreciated that the system described in FIG. 2 is only an example, and that many other configurations may exist. For example, a NOC may assist with the monitoring and control of hundreds or thousands of vehicles, and many types of web applications may exist.

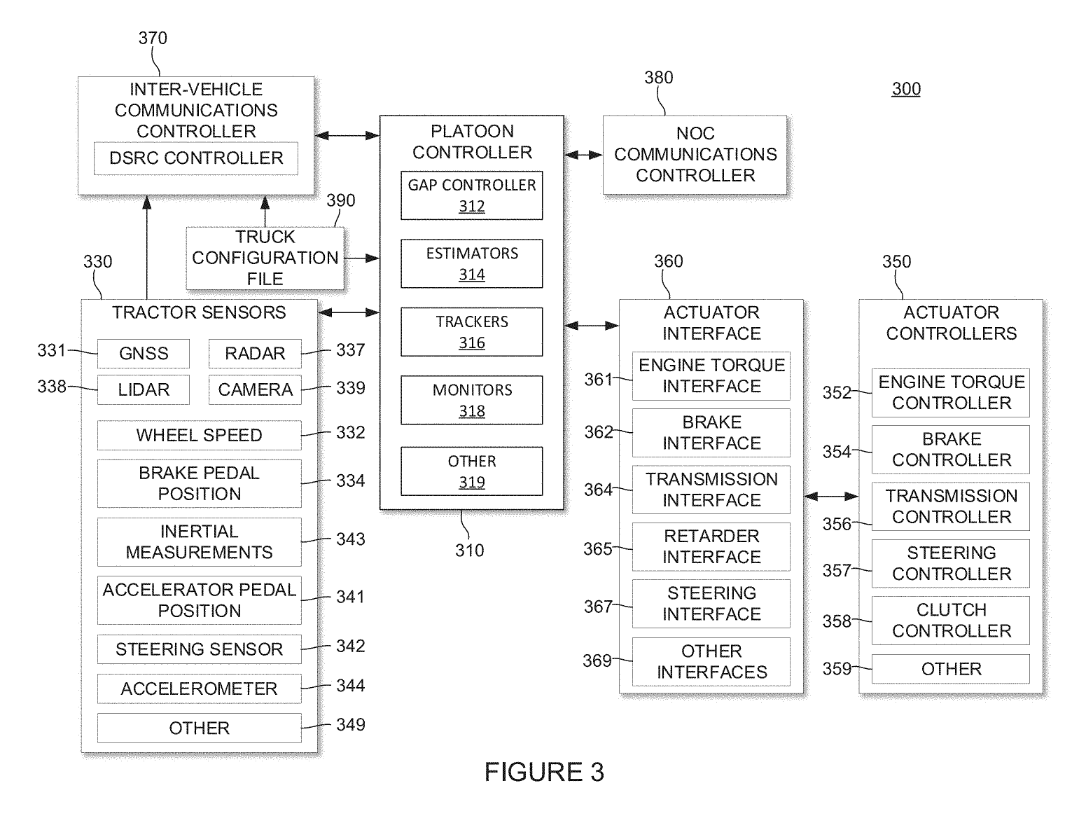

FIG. 3 illustrates and example system 300 including a platoon controller 310 (also referred to as a platoon electronic control unit, a platoon ECU, or a PECU). As described throughout this disclosure, a wide variety of configurations may be used to implement platooning systems described herein. The specific controller design can vary based on the level of automation contemplated for the controller, as well as the nature of and equipment available on the host vehicles participating in the platoon. FIG. 3 illustrates components of one possible configuration.

FIG. 3 diagrammatically illustrates a vehicle control architecture that can be suitable for use with platooning tractor-trailer trucks. The specific controller, or platooning ECU, illustrated is primarily designed for use in conjunction with a platooning system in which both vehicles include an active driver. The driver of the lead vehicle being fully responsible for control of the lead vehicle. In some embodiments the driver of the rear vehicle may be responsible for steering the rear vehicle, but the platoon controller 310 is primarily responsible for controlling the rear vehicle's torque and braking requests during active platooning. However, as discussed herein, it should be appreciated that generally similar control schemes can be used in systems which contemplate more automated control of one or both of the platoon partners or which utilize vehicle control commands other than or in addition to torque and braking requests.

In the example embodiment illustrated in system 300, a platoon controller 310, receives inputs from a number of sensors 330 on the tractor and/or one or more trailers or other connected units, and a number of actuator controllers 350 (also referred to as electronic control units or ECUs) arranged to control operation of the tractor's powertrain and other vehicle systems. An actuator interface 360 may be provided to facilitate communications between the platoon controller 310 and the actuator controllers 350. In some embodiments, one or more of the actuator interfaces 360 may be included in one or more of the actuator controllers 350 (e.g., an actuator interface may be included in an ECU). Platoon controller 310 also interacts with an inter-vehicle communications controller 370 (also referred to as an inter-vehicle communications ECU) which orchestrates communications with the platoon partner and a NOC communications controller 380 (also referred to as a NOC communication ECU) that orchestrates communications with a NOC. The vehicle also may have selected configuration files 390 that include known information about the vehicle.

Some of the functional components of the platoon controller 310 include gap controller 312, a variety of estimators 314, one or more partner vehicle trackers 316 and various monitors 318. In many applications, the platoon controller 310 will include a variety of other components 319 as well.

Some of the sensors utilized by platoon controller 310 may include GNSS unit 331, wheel speed sensors 332, inertial measurement devices 334, radar unit 337, lidar unit 338, cameras 339, accelerator pedal position sensor 341, steering wheel position sensor 342, brake pedal position sensor 343, and various accelerometers 344. Of course, not all of these sensors will be available on all vehicles involved in a platoon and not all of these sensors are required in any particular embodiment. A variety of other sensors 349 (now existing or later developed or commercially deployed) may be additionally or alternatively be utilized by platoon controller 310 in other embodiments.

Many (but not all) of the described sensors, including wheel speed sensors 332, radar unit 337, accelerator pedal position sensor 341, steering wheel position sensor 342, brake pedal position sensor 343, and accelerometer 344 are relatively standard equipment on newer trucks (tractors) used to pull semi-trailers. However, others, such as GNSS unit 331 and lidar unit 338 (if used) are not currently standard equipment on such tractors or may not be present on a particular vehicle and may be installed as needed or desired to help support platooning.

FIG. 3 also illustrates various actuator controllers 350. It should be understood that, in various embodiments, some or all types of controllers may be referred to interchangeably as electronic control units (ECUs). It should, however, be understood that some ECUs may control actuators, some ECUs may control communications, some ECUs may monitor sensors, and some may perform any combination thereof. Thus, it should be appreciated that the system shown in FIG. 3 is merely one of a wide variety of systems that may be used to control platooning.

Some of the vehicle actuator controllers 350 that platoon controller 310 may direct at least in part include engine torque controller 352; brake controller 354; transmission controller 356; steering/automated steering controller 357; and clutch controller 358. Of course, not all of these actuator controllers will be available or are required in any particular embodiment and it may be desirable to interface with a variety of other vehicle actuator controllers 359 that may be available on the vehicle as well. Therefore, it should be appreciated that the specific actuator controllers 350 directed or otherwise utilized by the platoon controller on any particular controlled vehicle may vary widely. Further, the capabilities of any particular actuator controller (e.g. engine torque controller 352), as well as its interface (e.g., the nature and format of the commands, instructions, requests and messages it can handle or generate) will often vary with the make and model of that particular actuator controller. Therefore, an actuator interface 360 is preferably provided to translate requests, commands, messages and instructions from the platoon controller 310 into formats that are appropriate for the specific actuator controller hardware and software utilized on the controlled vehicle. The actuator interface 360 also provides a mechanism for communicating/translating messages, commands, instructions and requests received from the various actuator controllers back to the platoon controller 310. In some embodiments, an appropriate actuator interface may be provided to interact with each of the specific vehicle controllers utilized. In various embodiments, this may include one or more of: an engine torque interface 361; a brake interface 362; a transmission interface 364; a retarder interface 365; a steering interface 367; and/or any other appropriate controller interface 369. In some embodiments, various controllers may be combined (e.g., in the case of a chasses controller, or an engine ECU that also controls a retarder—which may obviate the need for a retarder ECU).

Large trucks and other heavy vehicles frequently have multiple systems for “braking” the truck. These include the traditional brake system assemblies mounted in the wheels of the vehicle—which are often referred to in the industry as the “foundation brakes.” Most large trucks/heavy vehicles also have a mechanism referred to as a “retarder” that is used to augment the foundation brakes and serve as an alternative mechanism for slowing the vehicle or to help prevent the vehicle from accelerating down a hill. Often, the retarder may be controlled by the engine torque controller 352 and in such embodiments, the retarder can be controlled by sending appropriate torque commands (which may be negative) to engine torque controller 352. In other embodiments a separate retarder controller (not shown) may be accessible to, and therefore directed by, platoon controller 310 through an appropriate retarder interface 365. In still other embodiments, the platoon controller 310 may separately determine a retarder command that it sends to the actuator interface 360. In such embodiments the actuator interface will interpret the retard command and pass on appropriate retardation control commands to an Engine ECU or other appropriate vehicle controller.

The communications between vehicles may be directed over any suitable channel and may be coordinated by inter-vehicle communications controller 370. As described above, the DSRC protocol may work well.

The specific information transmitted back and forth between the vehicles may vary widely based on the needs of the controllers. In various embodiments, the transmitted information may include the current commands generated by the platoon controller 310 such as requested/commanded engine torque, and/or requested/commanded braking deceleration 382. They may also include steering commands, gear commands, etc. when those aspects are controlled by platoon controller 310. Corresponding information is received from the partner vehicle, regardless of whether those commands are generated by a platoon controller or other suitable controller on the partner vehicle (e.g., an adaptive cruise control system (ACC) or a collision mitigation system (CMS)), or through other or more traditional mechanisms—as for example, in response to driver inputs (e.g., accelerator pedal position, brake position, steering wheel position, etc.).

In many embodiments, much or all of the tractor sensor information provided to platoon controller 310 is also transmitted to the platoon partner and corresponding information is received from the platoon partner so the platoon controllers 310 on each vehicle can develop an accurate model of what the partner vehicle is doing. The same is true for any other relevant information that is provided to platoon controller 310, including any vehicle configuration information 390 that is relevant to platoon controller 310. It should be appreciated that the specific information transmitted may vary widely based on the requirements of platoon controllers 310, the sensors and actuators available on the respective vehicles, and the specific knowledge that each vehicle may have about itself.

The information transmitted between vehicles may also include information/data about intended future actions as will be discussed in greater detail below. For example, if the lead vehicle knows it is approaching a hill, it may expect to increase its torque request (or decrease its torque request in the context of a downhill) in the near future and that information can be conveyed to a rear vehicle for use as appropriate by the platoon controller 310. Of course, there is a wide variety of other information that can be used to foresee future torque or braking requests and that information can be conveyed in a variety of different forms. In some embodiments, the nature of the expected events themselves can be indicated (e.g., a hill, curve, or exit is approaching) together with the expected timing of such events. In other embodiments, the intended future actions can be reported in the context of expected control commands such as the expected torques and/or other control parameters and the timing at which such changes are expected. Of course, there are a wide variety of different types of expected events that may be relevant to the platoon control.

The communications between the vehicles and the NOC may be transmitted over a variety of different networks, such as a cellular network, various Wi-Fi networks, satellite communications networks and/or any of a variety of other networks as appropriate. The communications with the NOC may be coordinated by NOC communications controller 380. The information transmitted to and/or received from the NOC may vary widely based on the overall system design. In some circumstances, the NOC may provide specific control parameters such as a target gap. These control parameters or constraints may be based on factors known at the NOC such as speed limits, the nature of the road/terrain (e.g., hilly vs. flat, winding vs. straight, etc.) weather conditions, traffic or road conditions, etc. In other circumstances the NOC may provide information such information to platoon controller 310. The NOC may also provide information about the partner vehicle including its configuration information and any known relevant information about its current operational state such as weight, trailer length, etc.

Lastly, with regard to FIG. 3, configuration file 390 may include a wide variety of information about the host vehicle that may be considered relevant to controller 310. By way of example, some of the information might include the vehicle's specification including such things as engine performance characteristics, available sensors, the existence and/or type of platooning indicators (e.g., lights that indicate a vehicle is platooning), the nature of its braking system, the location of its GNSS antenna relative to the front of the cab, gear ratios, differential ratios etc.

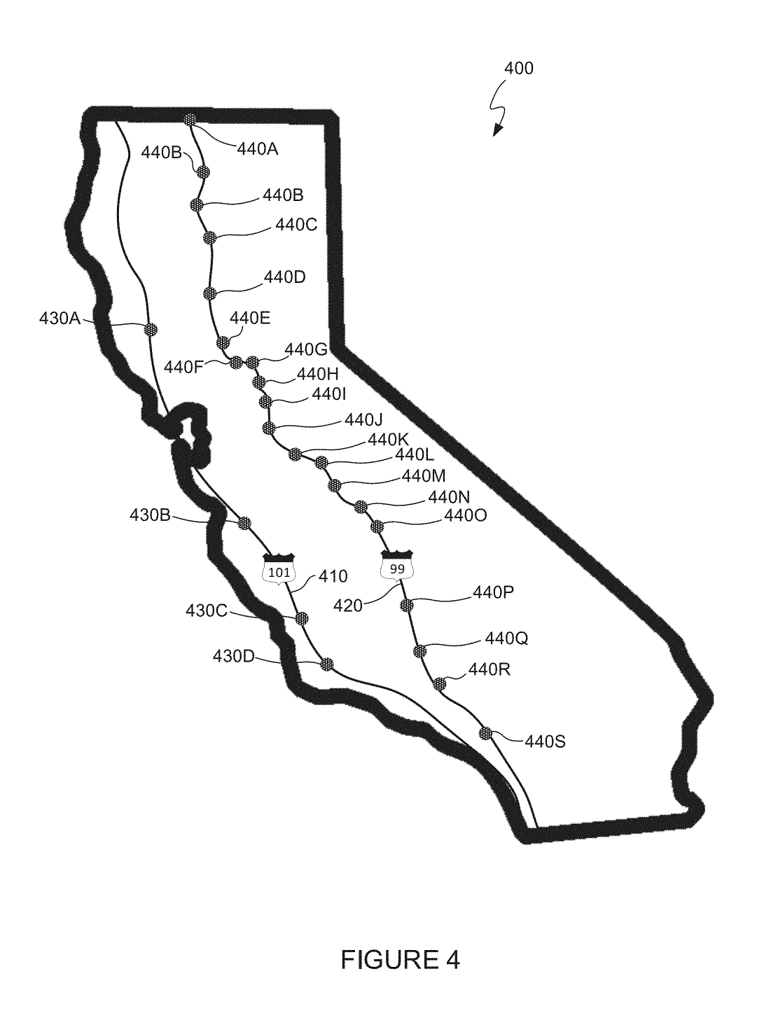

FIG. 4 illustrates an example map 400 including vehicles on roads, in accordance with some embodiments. Map 400 includes highway 101 410 and highway 99 420. On highway 101 410, there are symbols 430A-D indicating at least one vehicle capable of platooning. Similarly, on highway 99 420, there are symbols 440A-S indicating at least one vehicle capable of platooning. In some embodiments, a symbol on a display (e.g., 440A) may represent more than one vehicle. For example, symbol 440A may represent 4 trucks traveling on a road, wherein all four trucks are capable of platooning. In some embodiments, if a display were to zoom-in on (or if a user were to click on/select) a symbol 440A, and symbol 440A represented multiple vehicles, then four symbols may appear on the display and replace the single symbol 440A. In some embodiments a symbol (e.g., 440A) may be a different shape, or have a number within it and/or associated with it, to indicate that the symbol represents more than one vehicle. In some embodiments a symbol (e.g., 440A) may represent a certain number of platoonable vehicles, a certain number of non-platoonable vehicles, and/or a percentage/ratio of platoonable vehicles to non-platoonable vehicles.

In one or more embodiments, historical data may be used to generate symbols 430A-D and 440A-S. Historical data may include any data collected by a system other than real-time data. For example, historical data may include data received by a system from a third-party source. Such a third-party source may include Inrex™, Google™, Omnitracs™, PeopleNet™ Geotab™, etc. Historical data may also be collected by base stations (e.g., base station 130), a NOC 240, satellites 260, and/or vehicles 110, 112, 114, 116, 120, 122, 210 and 220. Regardless of where the data is collected, historical data may include information indicating with how many platoonable vehicles historically travel on a road at a particular time. (Note that data may be collected from platoonable vehicles and/or non-platoonable vehicles).

As discussed herein, historical data may include information about a density. E.g.,

$$\frac{Amount of Platoonable Vehicles}{Amount of roadway ( \begin{matrix}e . g . , number of lanes \times \\ a distance\end{matrix} )} = Destiny \qquad ( Equation 1 )$$

For example, map 400 indicates that highway 99 420 has a much higher density than highway 101 410. Map 400 may be shown on a display and be associated with a time period. Herein, a time period (or simply time) may include a window of time (e.g., 4:00 a.m.-7:00 a.m.), an exact time (e.g., 10:00 p.m.), and/or and a set of days/months/years (e.g., 6:00 a.m.-9:00 a.m. every Monday and Tuesday, every Saturday in December, 1:00 p.m. on weekdays, 6:00 a.m.-6:00 p.m. on the last day of a month, etc.). When determining density, systems and methods herein may receive and analyze data (e.g., from third-party sources) including, but not limited to: an average amount of vehicles that travel on at least one road; an amount of platoonable vehicles compared to a total amount of vehicles that travel on at least one road (e.g., a percentage of platoonable vehicles and/or a ratio of platoonable vehicles to non-platoonable vehicles); an average amount of platoonable vehicles that travel on a particular road at a particular time on a particular day of the week; an average amount of platoonable vehicles that travel on a set and/or subset of roads at a particular time; a type of vehicle that travels on at least one road during a time period; attributes of at least one vehicle that travels on at least one road during at least one time period; vehicle speeds; traffic congestion; an amount of exits; the amount of time vehicles spend platooning on at least one road; weather associated with at least on road; a road's location; and how safe it is to platoon on at least one road. It should be understood that the term “at least one road” may be used interchangeably with a section of a road, an entire road, sections of multiple roads, etc.

As an example, a fleet may desire that their vehicles platoon when traveling from Los Angeles, Calif. to Oregon. A user of a terminal may be able to access a map 400 (e.g., as part of a fleet management system) and determine that highway 99 420 has a higher density than highway 101 410. As such, the user (or the system if automated) may direct vehicles that are not already platooning to travel on highway 99 420 as opposed to highway 101 410, and this recommendation or action may also include an optimized timing for this travel, or other parameters to increase the ability to rendezvous such as a speed for one or more vehicles. A fleet may want its vehicles to travel on highway 99 420 because they may have a higher likelihood of rendezvousing with another platoonable vehicle and be able to platoon on their way to Oregon while traveling on highway 99 420. In some embodiments a system may recommend that a vehicle platoon with another vehicle the system is tracking based on data including, but not limited to: the distance between the two vehicles; how far the two vehicles are estimated to travel (which may be based on historical route data associated with at least one vehicle); what direction the vehicles are heading; and attributes associated with the vehicles such as their brakes and/or loads.

In one or more embodiments, ad hoc pairing may occur (e.g., pairing vehicles that are not employed by the same company and/or are not part of the same fleet, which may include passenger vehicles). For example, a system may be accessible by anyone with a subscription to the system. When a system is activated, it may provide information regarding what road a vehicle should travel on based on the likelihood that the vehicle will be able to platoon with another vehicle once it is on that road. In some embodiments, a driver may be able to access this information on a mobile device/terminal, which may also be configured to provide a user with an electronic trucking log (which can measure how much time a trucker is on the road). Using this system, for example, a driver may rely on the historical density and/or real-time data to show them that they should travel a route on highway 10 to Florida rather than taking highway 66. It is contemplated that in some embodiments a system may automatically cause/schedule a vehicle to travel on a route without human intervention.

As another example, a fleet may normally send one vehicle from its transportation hub in Los Angeles to San Francisco at 6:00 a.m. everyday via highway 101. That fleet may also send a second vehicle from its transportation hub in Los Angeles to San Francisco at 8:00 a.m. everyday via highway 101. In response to using the system and determining that platooning was more likely if a vehicle took highway 99 at 7:00 a.m. instead of taking highway 101 at 8:00 a.m., a system may recommend and/or schedule the second vehicle to leave the transportation hub in Los Angeles at 8:00 a.m. and have it travel on highway 99. In another example, a fleet may decide to send a pair of vehicles which are both configured to platoon at a particular time rather than one vehicle at 6:00 a.m. and another at 8:00 a.m.

As yet another example, a system may determine that one or more roads are unsafe to travel on based at least in part on an amount of vehicles platooning on that road at a given time (e.g., within the last hour, at this time of the year last year, etc.). By knowing, for instance, weather and how many vehicles are platooning on a road at a given time, a system or a user of a system may cause one or more vehicles to travel on a different route (e.g., based at least on the original route having fewer than a threshold amount of platooning vehicles traveling on it).

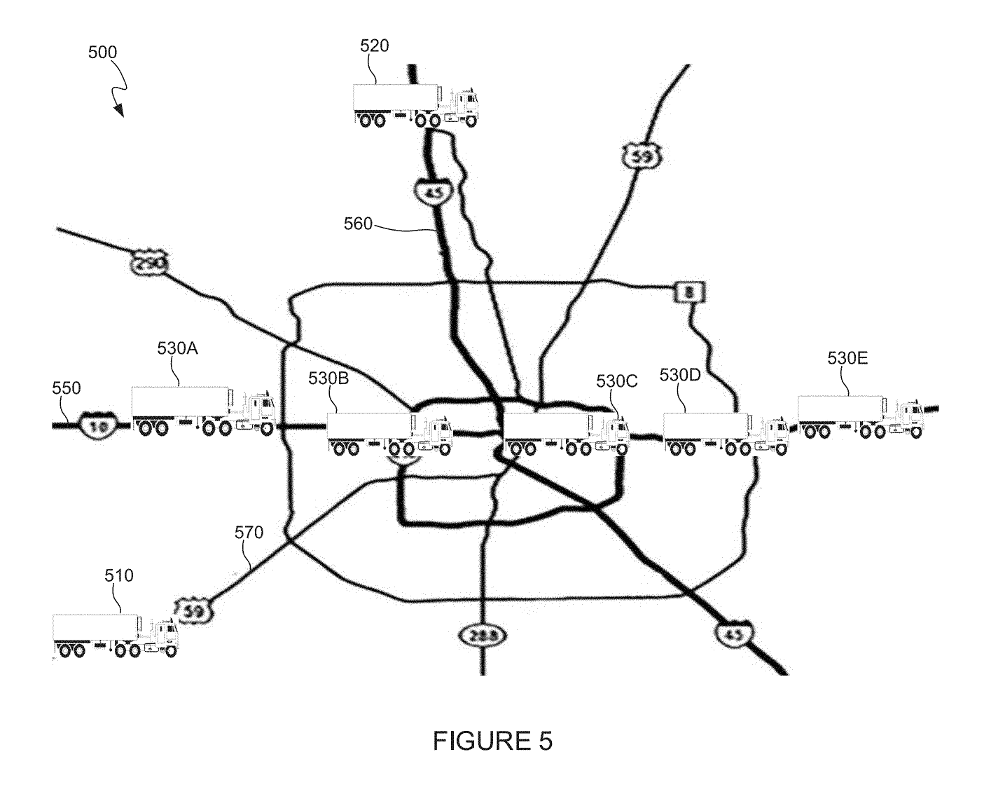

FIG. 5 illustrates an example map 500 including vehicles on roads, in accordance with some embodiments. Map 500 shows a group of roads 500 (in this case, highways), including highway 10 550, highway 45 560, and highway 59 570. In addition, map 500 depicts vehicle 520 traveling on highway 45 560, vehicle 510 traveling on highway 59 570, and vehicles 530A-E traveling on highway 10 550. In some embodiments, at least a portion of map 500 may be shown on a display of a terminal. For example, maps, vehicles, and their respective locations may be shown in real- or near-real time to a user of the systems described herein (e.g., a driver and/or a system manager).

In various embodiments, each vehicle 510, 520, and 530A-E may be able to communicate with one another, a network 230, a NOC 240, a satellite system 260, the cloud, and/or terminals (e.g., 256), etc. Data transmitted and received from the various vehicles 510, 520, and 530A-E may include information described above with reference to FIG. 1, including vehicle heading, platoonability, etc. Further, information may be transmitted and/or received indicative of the density of a road. For instance, vehicle 510 may send information indicating that highway 59 570 is not very dense, while vehicle 530D may send information indicating that highway 10 550 is dense. As a result, in some embodiments, a system may determine that vehicle 510 should travel on highway 10 550 such that it has a greater probability of platooning. Further, a system may determine that vehicle 510 should platoon with vehicle 530A on highway 10 550 when the two vehicles rendezvous (e.g., while traveling on highway 10 550, at a location off of highway 10 550 such as a truck stop, etc.). In some cases, a display may show a driver where a vehicle they are supposed to platoon with is located. For example, a display may indicate that a vehicle should speed up or slow down such that it becomes close enough to another vehicle to platoon.

In some embodiments, a system may provide a notification to a driver (e.g., via a GUI), or to a fleet manager (e.g., someone remotely monitoring a system), to cause a vehicle to change routes such that it has a better probability to platoon. For example, a user of the fleet management system may appear on display (e.g., a heads up display) within a vehicle and tell a driver to platoon with particular vehicle. As another example, a notification/person may tell a driver to leave their current location at a particular time to increase their likelihood of finding another vehicle to platoon with and/or to arrive at a particular place (e.g., to be travelling on highway 10 550 at mile marker 1,035) at a particular time to find a particular vehicle to platoon with.

In some embodiments, a display and/or other suitable communication system may provide a driver and/or fleet manager with information associated with various choices a driver and/or fleet manager may make. For instance, a system may provide information including, but not limited to: a time of a delay caused by slowing down to a rendezvous with another vehicle, an amount of fuel spent by speeding up, an amount of additional miles the driver's vehicle must travel if they travel a recommended route (e.g., a system may provide a driver and/or a fleet manager or others with the effects of modifying their planned route and/or timing to take a route that increases the likelihood they will platoon). In some embodiments, a system may at least partially automatically determine what route a vehicle will take and when based on various attributes. These attributes may include, but are not limited to: a time of a delay caused by slowing down to rendezvous with another vehicle, an amount of fuel spent by speeding up, an amount of additional miles the vehicle must travel if they travel a recommended route. For instance, if a threshold amount of one or more attributes is achieved a vehicle may continue on its planned route instead of modifying its route to increase its likelihood of platooning (e.g., if more than a particular amount of time and/or fuel would be spent by changing a vehicle's route in an attempt to increase that vehicle's chance of platooning, the vehicle will instead travel on its originally planned route).

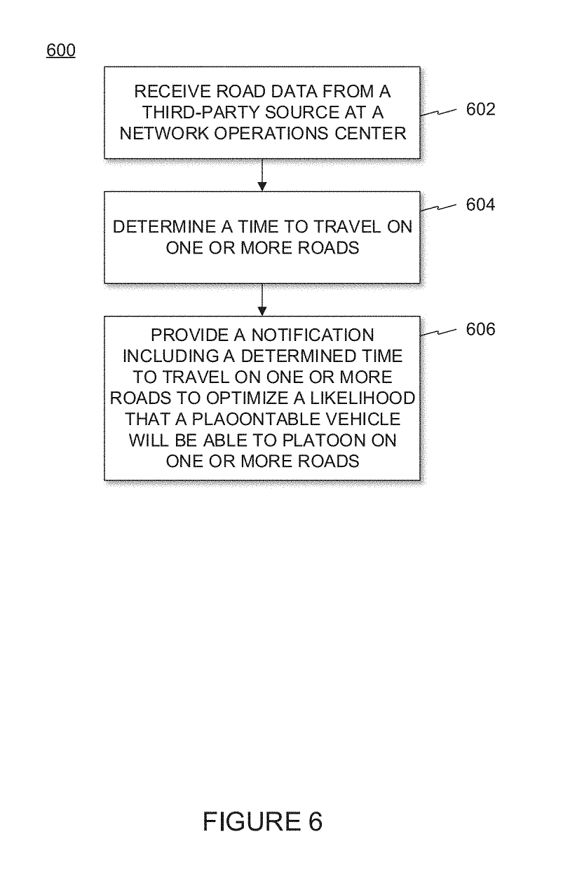

FIG. 6 shows a flowchart 600 of a method for determining a time for a platoonable vehicle to travel on one or more roads, in accordance with various embodiments. While the various steps in the flowchart is presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order. Accordingly, the specific arrangement of steps shown in FIG. 6 should not be construed as limiting the scope of the invention. In one or more embodiments, the steps of FIG. 6 can be performed by example system 100, 200, 300, and/or computing system 700.

In step 602, road data may be received from a third-party source at a network operations center. Such a third-party source may include Inrix™, Google™, Omnitracs™, PeopleNet™ Geotab™, etc.

Further, it is contemplated that in some embodiments road data may be received from components of a system itself (e.g., vehicles, base stations, etc.) as opposed to a third-party source). For example, information about a stretch of highway may be gathered by sensors in one or more vehicles—which may be platooning—and transmitted to another vehicle, the cloud, over a network, etc. (e.g., a vehicle's LIDAR(s) may scan a portion of a road and provide that information to other vehicles. In some embodiments certain road data may not be gathered by a system unless two or more vehicles are platooning while gathering data.

In some embodiments, road data may include historical and/or real time data associated with one or more roads. In various embodiments historical data may include an average number of platoonable vehicles traveling on at least a portion of one or more roads over a period of time. In some embodiments, historical data may include an average distance between platoonable vehicles that travel on a road (e.g., at a particular time). Historical data may also include other characteristics/attributes associated with a road, such as weather, construction, traffic, grades, wind, etc. Further, herein the term road may include, but is not limited to: highways, private road, public roads, thoroughfares, routes, bridges, avenues, drives, frontage roads, gravel roads, ice roads, streets, autobahns, freeways, tracks, motorways, portions of a road, dirt roads, roads to railheads and/or mines, turnpikes, and parkways.

In step 604, a time to travel on one or more roads is determined. This may include a determination of relative travel time (e.g., an amount of time added to a trip by taking a certain route versus taking another route) and decisions may be made based on the relative travel time (e.g., a driver, fleet manager, system, etc. may cause a vehicle not to travel on one of the routes). Generally, a time to travel on one or more roads may be determined using a number of factors including traffic, vehicle type, load type, vehicle health, weather, and an amount of platoonable vehicles on a road. For instance, determining a time to travel on one or more roads may be based on: (1) an estimated platoonable-vehicle density of one or more roads; and (2) a current location of a platoonable vehicle. An estimated platoonable-vehicle density of one or more roads may include an amount of platoonable vehicles (e.g., vehicles that can be controlled and/or commanded based at least in part on data received from another vehicle) traveling on at least a portion of the one or more roads. In some embodiments, a platoonable-vehicle density may be based on an average size of gaps (e.g., a distance or time headway) between platooning vehicles on a road. In some embodiments, a platoonable-vehicle density may be based on at least a portion of an amount of time that a set of platoonable vehicles have spent platooning on a road. In some embodiments, a platoonable-vehicle density of one or more roads may also be based on data received from a third-party source (e.g., a telematics and/or fleet management system) at a NOC.

In step 606 a notification is provided including a determined time to travel on one or more roads to optimize a likelihood that a platoonable vehicle will be able to platoon on one or more roads. For example, a message may be sent to a driver, fleet manager, system, or elsewhere that may indicate a time at which a platoonable vehicle should travel on a road to maximize the probability it will platoon. In some embodiments, the probability must be above a threshold amount in order for a notification to be sent.

In some embodiments, the term time may refer to: at least one specific time (e.g., 6:00:00 p.m.), at least one window of time (e.g., 6:00 p.m.-7:00 p.m.), at least one day of a week (e.g., Saturday), at least one month (e.g., January), at least one year (e.g., 2016), or any combination thereof. For example, a time may refer to:

6:00 p.m.-7:00 p.m. each Saturday in 2016;

5:00 a.m.-9:00 a.m. each weekday;

3:00 p.m.-10:00 p.m.;

11:00 p.m.; and

2:00 a.m.-4:00 a.m. and 4:00 p.m.-6:00 p.m. on Mondays, Wednesdays, and Fridays.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

This disclosure contains numerous references to a NOC and to one or more processors. According to various aspects, each of these items may include various kinds of memory, including non-volatile memory, to store one or more programs containing instructions for performing various aspects disclosed herein.

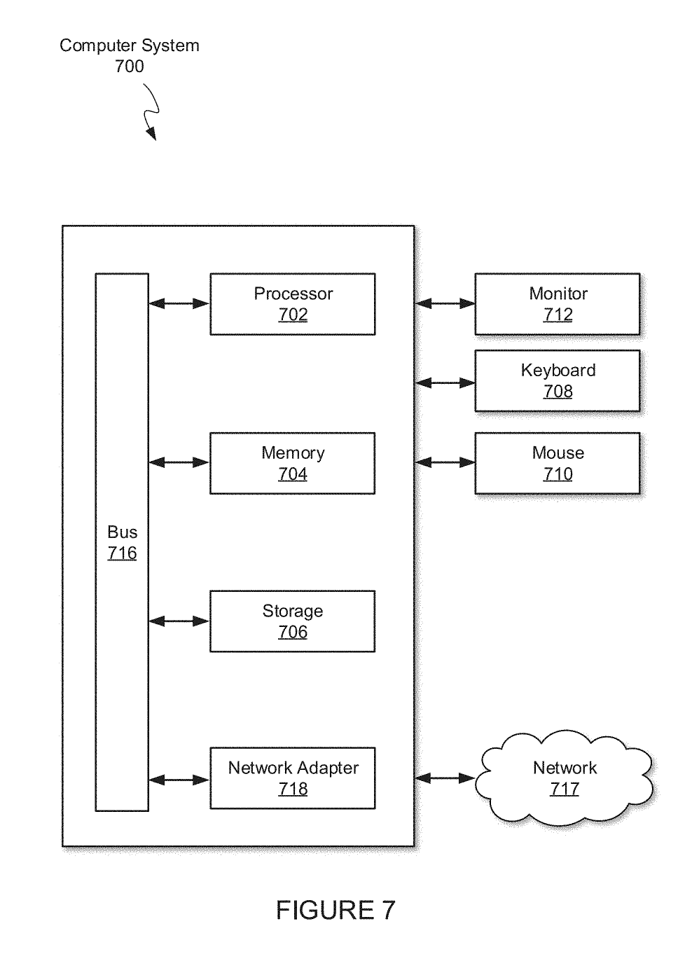

For example, as shown in FIG. 7, example computing system 700 may include one or more computer processor(s) 702, associated memory 704 (e.g., random access memory (RAM), cache memory, flash memory, read only memory (ROM), electrically erasable programmable ROM (EEPROM), or any other medium that can be used to store the desired information and that can be accessed to retrieve that information, etc.), one or more storage device(s) 706 (e.g., a hard disk, a magnetic storage medium, an optical drive such as a compact disk (CD) drive or digital versatile disk (DVD) drive, a flash memory stick, etc.), and numerous other elements and functionalities. The computer processor(s) 702 may be an integrated circuit for processing instructions. For example, the computer processor(s) may be one or more cores or micro-cores of a processor. The computing system 700 may also include one or more input device(s) 710, such as a touchscreen, keyboard, mouse, microphone, touchpad, electronic pen, or any other type of input device. Further, the computing system 700 may include one or more output device(s) 708, such as a screen (e.g., a liquid crystal display (LCD), a plasma display, touchscreen, cathode ray tube (CRT) monitor, projector, or other display device), a printer, external storage, or any other output device. The computing system 700 may be connected to a network 714 (e.g., a local area network (LAN), a wide area network (WAN) such as the Internet, mobile network, or any other type of network) via a network interface connection 718. The input and output device(s) may be locally or remotely connected (e.g., via the network 712) to the computer processor(s) 702, memory 704, and storage device(s) 706.

One or more elements of the aforementioned computing system 700 may be located at a remote location and connected to the other elements over a network 714. Further, embodiments of the invention may be implemented on a distributed system having a plurality of nodes, where each portion of the invention may be located on a subset of nodes within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet (e.g., the NOC). These cloud-based services (e.g., software as a service, platform as a service, infrastructure as a service, etc.) may be accessible through a Web browser or other remote interface.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment.

While this disclosure has been described in terms of several aspects, there are alterations, modifications, permutations, and equivalents which fall within the scope of this disclosure. In view of the many alternative ways of implementing the methods and apparatuses of the present disclosure, it is intended that the following appended claims be interpreted to include all such alterations, modifications, permutations, and substitute equivalents as falling within the true scope of the present disclosure.

What is claimed is:

1. A method for determining a time for a platoonable vehicle to travel on one or more roads, comprising:
receiving road data from a third-party source at a network operations center (NOC), wherein the road data comprises historical data associated with the one or more roads;
determining a time to travel on the one or more roads, wherein the determined time to travel on the one or more roads is based at least in part on:
an estimated platoonable-vehicle density of the one or more roads, wherein a platoonable-vehicle density of the one or more roads comprises an amount of platoonable vehicles traveling on at least a portion of the one or more roads, and wherein the estimated platoonable-vehicle density of the one or more roads is based on the data received from the third-party source at the NOC; and
a current location of the platoonable vehicle.

2. The method of claim 1, further comprising:
providing a notification comprising the determined time to travel on the one or more roads to optimize likelihood of the platoonable vehicle platooning on the one or more roads.

3. The method of claim 1, wherein the historical data comprises an average number of platoonable vehicles traveling on at least a portion of the one or more roads over a period of time.

4. The method of claim 1, wherein the historical data comprises an average distance between platoonable vehicles that travel on the one or more roads.

5. The method of claim 1, wherein the historical data comprises an average distance between platoonable vehicles that travel on the one or more roads at a particular time.

6. The method of claim 1, wherein receiving road data and determining a time to travel are functions of a fleet management system.

7. The method of claim 1, wherein the estimated platoonable-vehicle density of the one or more roads is based at least in part on one or more sizes of gaps on the one or more roads.

8. A system for determining a time to travel, wherein the system comprises:
a processor;
a memory; and
a network operations center, comprising the processor and the memory, configured to:
receive data associated with one or more roads; and
determine a time to travel on the one or more roads, wherein the determining the time to travel on the one or more roads is based at least in part on:
a platoonable-vehicle density of the one or more roads, wherein a platoonable-vehicle density of the one or more roads comprises an amount of platoonable vehicles traveling on at least a portion of the one or more roads; and
a location of the platoonable vehicle.

9. The system of claim 8, wherein the network operations center is further configured to:
cause a processor within a vehicle to cause a notification to be provided comprising the determined time to travel on the one or more roads.

10. The system of claim 8, wherein the data comprises an average number of platoonable vehicles traveling on at least a portion of the one or more roads over a period of time.

11. The system of claim 8, wherein the data comprises an average gap between platoonable vehicles on the one or more roads.

12. They system of claim 8, wherein the network operations center is further configured to:
schedule times for vehicles to leave various locations.

13. A method for determining where to platoon, comprising:
receiving historical data about one or more roads including an amount of vehicles that have platooned on the one or more roads; and
determining a time for a platoonable vehicle to travel on the one or more roads based at least in part on the amount of vehicles that have platooned on the one or more roads.

14. The method of claim 13, further comprising:
receiving data including a platoonable-vehicle density of the one or more roads, wherein the platoonable-vehicle density of the one or more roads is based on an amount of platoonable vehicles traveling on at least a portion of the one or more roads.

15. The method of claim 14, wherein the data is received at a network operations center (NOC) from a third-party source.

16. The method of claim 13, further comprising:
providing a notification comprising the determined time for the platoonable vehicle to travel on the one or more roads to a terminal display.

17. The method of claim 13, further comprising:
providing notifications to two or more trucks, wherein the notifications include information associated with the determined time for the platoonable vehicle to travel on the one or more roads.

18. The method of claim 14, wherein the platoonable-vehicle density of the one or more roads is further based on at least a portion of an amount of time a set of platoonable vehicles have spent platooning on the one or more roads.

19. The method of claim 13, wherein the determined time is further based on weather and traffic on the one or more roads.

20. The method of claim 13, further comprising:
receiving historical data about the one or more roads including times that the vehicles that have platooned on the one or more roads platooned, and wherein the determination of the time for the platoonable vehicle to travel on the one or more roads is further based at least in part on the times that the vehicles that have platooned on the one or more roads platooned.
